(19) United States
(12) Patent Application Publication
(10) Pub. No.: US 2021/0142230 A1
(43) Pub. Date: May 13, 2021

(54) System and Method for Electronic Reservation and Scheduling of Golf Outings

(71) Applicant: Scott Revey, Nashville, TN (US)

(72) Inventor: Scott Revey, Nashville, TN (US)

(21) Appl. No.: 17/093,358

(22) Filed: Nov. 9, 2020

Related U.S. Application Data
(60) Provisional application No. 62/932,221, filed on Nov. 7, 2019.

(51) Int. Cl. G06Q 10/02; G06Q 10/10; H04W 4/02; H04W 4/029

(52) U.S. Cl. CPC G06Q 10/02; H04W 4/029; H04W 4/023; G06Q 10/1093

(57) ABSTRACT

An electronic method of creating a group golf game includes: providing a server; storing data corresponding to one or more user accounts on a database; receiving from a first user device a request to create a first golf group; transmitting a request to at least a second user device to join the first golf group on the server; in response to an acceptance of the request to join the first golf group from the second user device, associating a user corresponding to the second user device with the first golf group; receiving a request from one of the first user device and the second user device to create a golf event; creating a first golf event on the server, the first golf event corresponding to the first golf group such that the golf event is accessible by one of the first user device and the second user device.

### CROSS-REFERENCE TO RELATED APPLICATION

This application claims priority to and is a non-provisional of U.S. Provisional Patent Application Ser. No. 62/932,221 for a “System and Method for Electronic Reservation and Scheduling of Golf Outings” filed on Nov. 7, 2020, the contents of which are incorporated herein by reference in its entirety.

### FIELD

This disclosure relates to the field of coordinating electronic golf reservations. More particularly, this disclosure relates to systems and methods for electronic reservation and scheduling of golf outings received through a plurality of user devices.

### BACKGROUND

Various services exist that allow golfers to electronically reserve a tee time at one of several courses online. However, these services make it difficult for golfers to discreetly send course booking invitations within specific time, geographic location, and contact subgroup parameters, all while allowing each player to pay individually. Further, it is the first application to allow for random pairings of golfers within adjustable search parameters as determined by profile information. Other applications in this field require a single user to reserve and pay for a tee time online, thereby requiring the golfer to subsequently obtain reimbursement from other members of a golf group. If they want to schedule with a set group of friends this is currently only coordinated through a group chat, which can be highly disruptive while at work and the invitation may not extend to everyone that given conversation thread. Further, coordination may be difficult in determining a number of golfers planning to play as part of a group, whereas this application would combine real-time communication among players, a way to make new connections with golfers in your area who share your interests, and allowing for booking of group tee-times where everyone can pay individually.

Golfers frequently play with regular groups, but social relationships can change and evolve. For example, some golfers may typically play with a regular group or groups on certain days of the week, such as weekend and weekday groups. While other golfers might desire to play with someone they may not yet know but have identified some common interests and convenient courses, as well a potentially matching by skill-level. No application currently on the market brings the feel of country club concierge service to the casual golfer, while having the slick user experience of “matching” with other golfers that is akin to matching with a driver on Uber or Lyft or even on Tinder.

Further problems may exist with coordinating requests for golf outings from various user devices corresponding to various users. For example, it may be difficult to pair users together based on requests for a golf outing received from various users on various user devices.

What is needed, therefore, is a system and method for electronic reservation and scheduling of golf events across customizable subgroups (including “random”), locations, times, and skill-level, all while allowing golfers to pay the course's green fees individually.

### SUMMARY

The above and other needs are met by a system and method for electronic reservation and scheduling of golf events across customizable subgroups. In a first aspect, an electronic method of creating a group golf game includes: providing a server having a processor and a database in electronic communication with the processor; storing data corresponding to one or more user accounts on the database; receiving from a first user device a request to create a first golf group on the server; transmitting a request to at least a second user device to join the first golf group on the server; in response to an acceptance of the request to join the first golf group from the second user device, associating a user corresponding to the second user device with the first golf group; receiving a request from one of the first user device and the second user device to create a golf event; creating a first golf event on the server, the first golf event corresponding to the first golf group such that the golf event is accessible by one of the first user device and the second user device.

In one embodiment, methods further include providing a user interface displayable on the first user device and the second user device, wherein the user interface displays the first golf event on the first user device and the second user device.

In another embodiment, methods further include determining a location of one of the first user device and the second user device; displaying the first golf event on the first user device and the second user device if the first user device and the second user device are determined to be within a designated geographic proximity to a location of the first golf event.

In yet another embodiment, methods include receiving a request from a third user device to create a second golf group and associating one or more additional user devices with the second golf group.

In one embodiment, methods include transmitting a request from the server to a computer of a golf course requesting a tee time for the first golf event.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a home screen of a user interface according to one embodiment of the present disclosure;

FIG. 2 shows a group selection page of a user interface according to one embodiment of the present disclosure;

FIG. 3 shows a time selection page of a user interface according to one embodiment of the present disclosure;

FIG. 4 shows a course selection page of a user interface according to one embodiment of the present disclosure;

FIG. 5 shows a player status page of a user interface according to one embodiment of the present disclosure;

FIG. 6 is a schematic illustration of an exemplary user device according to one embodiment of the present disclosure;

FIG. 7 shows a home screen of a user interface on a user device according to one embodiment of the present disclosure;

FIG. 8 shows a search screen of a user interface on a user device according to one embodiment of the present disclosure;

FIG. 9 shows an interface for creating a golf game on a user device according to one embodiment of the present disclosure;

FIG. 10 shows a page of a golf game on a user device according to one embodiment of the present disclosure;

FIG. 11 shows a page of requests to join a golf game on a user device according to one embodiment of the present disclosure;

FIG. 12 shows a group page on a user device according to one embodiment of the present disclosure; and

FIG. 13 shows a system for electronically creating and managing a group golf outing according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments described herein describe systems and methods of electronic reservation and scheduling of golf outings for groups of golfers. Systems and methods described herein are implemented on a computer or smartphone and enable golfers to electronically coordinate and fill tee times for groups of golfers. Users may view and customize groups and subgroups of golfers and electronically book tee times for groups and subgroups of golfers. Further, individual members of each group or subgroup may electronically reserve and pay for their respective tee time within the reservation made for the group by another user.

Contacts of a user may be stored on a server and associated with the user. Contacts may be input such as by manually inputting contact information on a user device by the user and storing the input contact information on the server. Contact information may include a name, email address, phone number, and other information for each contact. Alternatively, contacts of a user may be received on the server such as by linking various social media or other accounts of the user such that contact information is retrieved and stored on the server.

After corresponding a plurality of contacts with the user, the user may subsequently create groups and/or subgroups of contacts using a user interface displayed to the user on a display of a user device. The user may first create one or more groups and/or subgroups and input a name of each group or subgroup. For example, groups and subgroups could include a “Friends” subgroup, a “Co-worker” subgroup, a “Neighborhood” subgroup, and other similar groups or subgroups of contacts. After creating a group or subgroup of contacts, the user may subsequently add contacts to the groups or subgroups of contacts. In one embodiment, the user may drag and drop contacts to one or more groups or subgroups. In another embodiment, each contact may be “tagged” as part of a particular group or subgroup of contacts. Each contact may be designated with more than one group or subgroup by the user. In one embodiment, each contact may be initially designated as part of a particular or subgroup based on data associated with the contact. For example, if a contact was added from a social media account of the user, the contact may be automatically designated as part of a “Friend” group or subgroup of the user.

The user may input additional preferences into a profile of the user, such as a geographic location of the user, preferred golf courses of the user, preferred times of day for playing a round of golf, and other preferences of the user. Additional preferences may include whether the user prefers to walk or ride a round of golf, a number of golfers with which the user prefers to play with, a type of tee where the user plays, and a handicap of the user.

Methods herein include reservation of a tee time by the user to play a round of golf with one or more contacts of the user. On a home page of a user interface displayed to the user on the user device, the user provides an input to set up a round of golf. In a first step, the user inputs one or more selections corresponding to contacts of the user to play the round of golf with. The user is preferably displayed the one or more group and subgroups associated with the user which are displayed to the user on the user device. The user may select a particular group or subgroup, or alternatively may select two or more groups and/or subgroups of contacts of the user. For example, the user may select one or more of groups associated with the user such as “Friends”, “Co-workers”, and other groups of the user.

In one embodiment, the user may select an option for random assignment of golfers for the user to play a round of golf with. If the user selects the option of random assignment of golfers, data from the golfer's profile is analyzed and the golfer is matched with other golfers based on data from other golfer's profiles stored on a server. Data including handicap, location, desired date and time, age, course preference, and other factors is analyzed for pairing the golfer with other randomly assigned golfers desiring to play a round of golf. In one embodiment, the user may request that one or more golfers be randomly added to contacts of the user for the round of golf. For example, if a list of contacts includes 3 golfers, the user may desire to add an additional random golfer to complete a foursome of the group for the round of golf.

In a next step, the user inputs a date and time for a desired round of golf for the user and designated contacts. The user may input a particular date and start time on the user device. Alternatively, the user may input a range of times or multiple dates and times for matching the user and designated contacts with one or more courses and available tee times of those courses.

After inputting one or more dates and times, the user next inputs one or more desired courses for the round of golf. In one embodiment, a list of preferred courses of the golfer is retrieved and displayed on the user device. The list of preferred courses may further include a designation of whether a tee time is available at the golfer's desired time and date. In one embodiment, the user may perform a search for available golf courses such as by searching for public or private courses within a particular geographic area. The user may input a zip code, address, city name, or other location information. Further, the user may input a desired range surrounding the geographic information. In another embodiment, a map is displayed on the user device and the user may outline an area on the map for a location of desired golf courses. In one embodiment, the user may select multiple available golf courses for the desired date and time of the golfer as options for playing a round of golf with the user's designated group of golfers.

In a next step, a list of golfers from the user's designated contacts are displayed for pairing of groups by the user. The user may group the user's contacts into one or more foursomes for the round of golf. The user may view on the user device a list of all names of golfer's playing the round of golf, including randomly assigned golfers, course information, and whether members of the groups have completed payment or otherwise confirmed participation in the round of golf.

When the user creates pairings of contacts of the user, confirmation of the pairings is transmitted to the users for the contacts to confirm participation in the round of golf. Further, contacts are directed to create an account for the contact or to enter payment information such that each of the participants of the round of golf may pay a greens fee of the participant. Each contact may create an account including information of the contact such as identifying information, payment information, and course/golf preference information.

As each contact provides payment for the round of golf, a display shown to the user on the user's device indicates which golfers have confirmed participation in the golf outing and which golfers have yet to submit payment or confirm attendance. Each contact may provide payment information and an authorization to charge the contact when the tee time is finally booked. Payment information is stored on a server for the contact such that the information may be subsequently retrieved for payment upon reservation of the tee time. Each contact may have the option of selecting an input to decline participation in the golf game. If the contact declines participation, a status of the contact will indicate to other users or participants that the contact is not participating.

In one embodiment, each contact may input a preferred golf course or time for the golf game. Embodiments herein may include a poll taken of contacts or members of groups and/or subgroups as to a preference in time, location, or other factors for the round of golf. The user creating the golf outing may then select a golf course based on input received from the one or more contacts or golfers of the group. Alternatively, the golf course may be automatically selected based on votes received from members of the group.

Upon confirmation of attendance of the contacts, embodiments include automatic electronic reservation of a tee time at the golf course selected by the user and/or group members. Further, payment is processed to the desired golf course by retrieving payment information from the group members such that any greens fees may be pre-paid to the golf course prior to the golf outing. Data is preferably transmitted to a computer of the golf course, including participant names, payment information, and other data of the user and group members for reservation of the tee time.

Referring to FIG. 1, a home screen 10 of a user interface 12 is shown on a user device 14. The home screen 10 of the user interface 12 includes a plurality of user inputs 16 that are selectable by a user on the user device 14. Exemplary user inputs 16 on the home screen 10 of the user interface 12 include “groups/golfers”, “courses near me”, “play golf”, “handicap”, and “blog”.

Referring to FIG. 7, in one embodiment the home screen 10 may a list of golf games available to the user on the user device 14. Available golf games may be displayed on the user device 14 based on whether those golf games are available to the user on the user device 14. The home screen 10 may display a location of the user device 14. Golf games displayed to and available to the user may be displayed to the user on the home screen 10 based at least in part on the location of the user device 14, such as by only displaying golf games that are within a desired geographic proximity to the user device 14. The user may optionally enter through the user interface 12 a desired location for a golf game, and golf games displayed on the home screen 10 may be based on the user-inputted desired location. For example, as shown in FIG. 8, a user may enter a search location into a search field 18 on the user interface 12 to locate golf games in proximity to the desired search location as described in greater detail herein. As the user inputs characters for a desired search location, corresponding matching locations may be displayed on the user interface 12 that match the characters inputted by the user on the user interface 12.

Referring again to FIG. 7, information related to the golf games is displayed on the user interface 12 including a name of the event, location of the event, number of members required for the event, how many members have already joined the event, and whether the event is public or private. The user may select to join the event through the user interface 12 if the golf game is available to that user to join. Golf games may be displayed to the user on the user interface 12 if the golf games are available to the user. The golf games may be determined to be available to the user, for example, if the golf game is created as a public event with one or more available spots in the golf game. Golf games may also be displayed to the user on the user interface 12 if the user is determined to be a member of a private group based on data associated with a user account of the user. For example, if the user is a member of one or more private groups, and members of those one or more private groups create a golf game, the user may be able to view the golf games associated with those private groups.

Referring now to FIG. 9, a page for creating a golf event on the user interface 12 is shown. On the user interface 12 of the user device 14, the user may input various parameters of a golf game, such as a golf game shown in on the user interface of FIG. 7. For example, the user may select on the user interface 12 whether the event is a public or private event, a date and time of the event, title of the event, venue of the event, number of members, and a description of the event. The user may select to “post” the golf game such that the golf game is then visible to appropriate users on the user interface 12 of those members' user devices 14. Referring to FIGS. 3-5, additional data may be received from a creator of a golf game, such as a desired time to play, a desired course, and assigned pairings of members of the golf game.

Referring to FIG. 10, when a user desires to join a golf game that is displayed on the user interface 12, the user selects one of the golf games on the user interface 12 and may be shown the display of FIG. 10. To join a golf game, the user selects an input to request to join the golf game. The request may be displayed on the user device 14 of a creating user of the golf game for approval or denial of the request to join the golf game. For example, as shown in FIG. 11 one or more requests may be displayed to the user on the user device 14 to either accept or reject.

Referring to FIG. 6, examples of computing devices suitable for the user device 14 include a desktop computer, a laptop computer, a tablet computer, a mobile computing device (such as a smart phone, a tablet device, or other mobile devices), or other devices configured to process digital instructions.

FIG. 12 shows an embodiment of a group page on the user interface 12 according to one embodiment. The group page may display one or more members associated with the group. The group page may further display a status of the group, such as whether the group is open and available such that additional members may join. Referring to FIG. 2, a group may be created by designating a type of group to be created.

The system memory 1582 includes read only memory 1586 and random-access memory 1588. A basic input/output system 1590 containing the basic routines that act to transfer information within computing device 1510, such as during start up, is typically stored in the read only memory 1586.

The computing device 1510 also includes a secondary storage device 1592 in some embodiments, such as a hard disk drive, for storing digital data. The secondary storage device 1592 is connected to the system bus 1584 by a secondary storage interface 1594. The secondary storage devices 1592 and their associated computer readable media provide nonvolatile storage of computer readable instructions (including application programs and program modules), data structures, and other data for the computing device 1510.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1592 or memory 1582, including an operating system 1596, one or more application programs 1598, other program modules 1500 (such as the software engines described herein), and program data 1502. The computing device 1510 can utilize any suitable operating system, such as Microsoft Windows™ Google Chrome™, Apple OS, Linux, Unix, and any other operating system suitable for a computing device. Other examples can include Microsoft, Google, or Apple operating systems, or any other suitable operating system used in computing devices.

In some embodiments, a user provides inputs to the computing device 1510 through one or more input devices 1504. Examples of input devices 1504 include a keyboard 1506, mouse 1508, microphone 1510, and touch sensor 1512 (such as a touchpad or touch sensitive display). Other embodiments include other input devices 1504. The input devices are often connected to the processing device 1580 through an input/output interface 1514 that is coupled to the system bus 1584. These input devices 1504 can be connected by any number of input/output interfaces, such as a parallel port, serial port, game port, or a universal serial bus. Wireless communication between input devices and the interface 1514 is possible as well, and includes infrared, BLUETOOTH® wireless technology, 802.11a/b/g/n, cellular, or other radio frequency communication systems in some possible embodiments.

In this example embodiment, a display device 1516, such as a monitor, liquid crystal display device, projector, or touch sensitive display device, is also connected to the system bus 1584 via an interface, such as a video adapter 1518. In addition to the display device 1516, the computing device 1510 can include various other peripheral devices (not shown), such as speakers or a printer.

When used in a local area networking environment or a wide area networking environment (such as the Internet), the computing device 1510 is typically connected to a network through a network interface 1520, such as an Ethernet interface. Other possible embodiments use other communication devices. For example, some embodiments of the computing device 1510 include a modem for communicating across the network.

The computing device 1510 typically includes at least some form of computer readable media. Computer readable media includes any available media that can be accessed by the computing device 1510. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1510.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 6 is also an example of programmable electronics, which may include one or more such computing devices, and when multiple computing devices are included, such computing devices can be coupled together with a suitable data communication network so as to collectively perform the various functions, methods, or operations disclosed herein.

Referring to FIG. 13, one or more of the user devices 14 may be in communication with a server 100, such as over a network 102. The server may include a processor 104 and a database 106 or storage in communication with the processor 104. User data may be stored on the database 106 and saved or retrieved by the processor 104, such as in response to inputs received through the one or more user devices 14. For example, data associating user accounts with one or more groups for the golf games may be stored on the database 106. The server 100 may be particularly configured to send and receive data to and from the one or more user devices 14 to display the golf games on the user devices 14 and to determine whether a user on the user device 14 corresponds to a particular group for a golf game. The server 100 and one or more user devices 14 may further be in electronic communication with one or more computers 108 corresponding to one or more golf courses such that a tee time may be reserved for a golf game at the one or more golf courses and to further facilitate payment of greens fees.

Embodiments of systems and methods described herein advantageously enable a user to reserve a tee time at a desired golf course with one or more contacts of the user such that group golf outing may be orchestrated. Systems herein advantageously collect data from group members planning to participate in the golf outing such that information may be subsequently provided to the golf course for reservation of a tee time. The user is able to group multiple golfers together in a golf outing without requiring the user to individually pay for all group members greens fees.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An electronic method of creating a group golf game, the method comprising:
providing a server having a processor and a database in electronic communication with the processor;
storing data corresponding to one or more user accounts on the database;
receiving from a first user device a request to create a first golf group on the server;
transmitting a request to at least a second user device to join the first golf group on the server;
in response to an acceptance of the request to join the first golf group from the second user device, associating a user corresponding to the second user device with the first golf group;
receiving a request from one of the first user device and the second user device to create a golf event;
creating a first golf event on the server, the first golf event corresponding to the first golf group such that the golf event is accessible by one of the first user device and the second user device.

2. The electronic method of creating a golf game of claim 1, further comprising providing a user interface displayable on the first user device and the second user device, wherein the user interface displays the first golf event on the first user device and the second user device.

3. The electronic method of creating a golf game of claim 2, further comprising:
determining a location of one of the first user device and the second user device;
displaying the first golf event on the first user device and the second user device if the first user device and the second user device are determined to be within a designated geographic proximity to a location of the first golf event.

4. The electronic method of creating a golf game of claim 1, further comprising receiving a request from a third user device to create a second golf group and associating one or more additional user devices with the second golf group.

5. The electronic method of creating a golf game of claim 1, further comprising transmitting a request from the server to a computer of a golf course requesting a tee time for the first golf event.
